(19) United States
(12) Patent Application Publication
(10) Pub. No.: US 2007/0216520 A1
(43) Pub. Date: Sep. 20, 2007

(54) Warning system for warning a following vehicle

(76) Inventor: Chih-Jung Ho, Hsin Chu City (TW)

Correspondence Address: BIRCH STEWART KOLASCH & BIRCH, PO BOX 747, FALLS CHURCH, VA, 22040-0747, US

(21) Appl. No.: 11/715,465

(22) Filed: Mar. 8, 2007

(30) Foreign Application Priority Data
Mar. 9, 2006 (TW) 095107880

(51) Int. Cl. B60Q 1/00; H04N 7/18

(52) U.S. Cl. 340/435; 348/148

(57) ABSTRACT

A warning system for warning a following vehicle includes a distance measuring unit, a calculating unit, a warning unit, a video recording unit and a display unit. The distance measuring unit measures a distance to the following vehicle, and the warning unit shows warning information if the following vehicle does not keep a safe distance. When the distance is smaller than a threshold distance, the video recording unit records video of the following vehicle. Thus, the warning system can effectively warn a driver who does not keep the safe distance, and provide a direct evidence for policing the driver who disobeys traffic rules so that the good driving environment can be obtained. Meanwhile, it is also possible to provide a reference to tell the driver the speed and the distance of the following vehicle through the display unit.

### BACKGROUND OF THE INVENTION

This application claims the benefit of the filing date of Taiwan Application Ser. No. 095107880, filed on Mar. 9, 2006, the content of which is incorporated herein by reference.

### FIELD OF INVENTION

The invention relates to a warning system, and more particularly to a warning system for measuring a distance to a following vehicle.

### RELATED ART

When driving on a highway, a small vehicle driver often finds that a heavy truck driver does not keep a safe distance on purpose and the heavy truck follows the small vehicle closely in order to force the small vehicle to yield to the heavy truck. If the small vehicle yields to the heavy truck, the pressure of the too short distance to the following vehicle can be eased. However, when the traffic is heavy and the following vehicle does not keep a safe distance to force the small vehicle to change the lane, the condition of the small vehicle will become more dangerous.

At present, the active safety warning system mainly aims on the condition in front of the vehicle. The distance to the front vehicle can be measured through an auxiliary brake system in conjunction with a radar disposed in the front of the vehicle. When the gap between the vehicle and the front vehicle is too small, or the approaching speed is too high, the system issues a warning message. If the system judges that the danger of collision is high, the system automatically calculates to provide the ideal auxiliary braking force and can compensate for the braking force applied by the driver through the brake pedal so as to prevent the collision. However, the safety protection of the driver still cannot be satisfied.

FIG. 1 is a schematic illustration showing an anti-collision warning system 10. Referring to FIG. 1, the anti-collision warning system 10 includes a reverse state detecting unit 11, an ultrasonic probe 12, a speed detecting unit 13, a central processing unit 14 and a warning unit 15. The reverse state detecting unit 11 detects whether the vehicle is in a reverse state. If yes, the reverse radar (not shown) is enabled, or otherwise the ultrasonic probe 12 and the speed detecting unit 13 are enabled to measure the distance and the speed to the following vehicle. Then, the central processing unit 14 judges whether the safe distance is kept. The warning unit 15 is enabled to warn the driver that the following vehicle does not keep the safe distance using a buzzer.

However, the ultrasonic probe 12 of the anti-collision warning system 10 is only suitable for the low speed running of the vehicle to increase its anti-collision efficiency. When the following vehicle does not keep the safe distance on purpose, the driver's pressure will be increased, and it is a great loading to the driver with the addition of the sound of the buzzer.

Thus, it is an important subject to effectively prevent the following vehicle from not keeping the safe distance and from following the vehicle too closely to cause the danger.

### SUMMARY OF THE INVENTION

It is therefore an object of the invention to provide a warning system for warning a driver in a following vehicle that does not keep a safe distance using a warning bulb and a video recorder disposed on a rear portion of the vehicle so as to ensure the travelling safety.

The invention achieves the above-identified object by providing a warning system including a distance measuring unit, a calculating unit, a warning unit, a video recording unit and a display unit disposed on a rear portion of a vehicle. The distance measuring unit is disposed on the vehicle, measures a distance to a following vehicle, and outputs a measured target distance parameter. The calculating unit receives the target distance parameter and a running speed of the vehicle, and compares the target distance parameter with a first distance parameter and a second distance parameter to judge whether a warning signal and a video recording control signal have to be outputted. The warning unit receives the warning signal and generates a warning operation according to the warning signal. The video recording unit receives the video recording control signal and starts to record video in a backward direction of the vehicle according to the enabled video recording control signal. The display unit displays the video on the back of the vehicle and displays the running speeds of the vehicle and the following vehicle as well as the distance from the vehicle to the following vehicle.

The warning system according to the invention utilizes the distance measuring unit to measure a safe distance between the following vehicle and the vehicle. If the safe distance is not kept, the system enables the warning unit to output at least one of warning texts, warning information and a brake light to warn the following vehicle to keep the safe distance. Meanwhile, the video recording unit can record the video for evidence. Thus, it is possible to effectively warn the driver who does not keep the safe distance, and can provide a direct evidence for policing the driver who disobeys the traffic rules. Thus, a good vehicle driving environment can be provided and the safer space for the driver can be obtained.

### BRIEF DESCRIPTION OF THE DRAWINGS

FIG. 1 is a schematic illustration showing a conventional collision warning system.

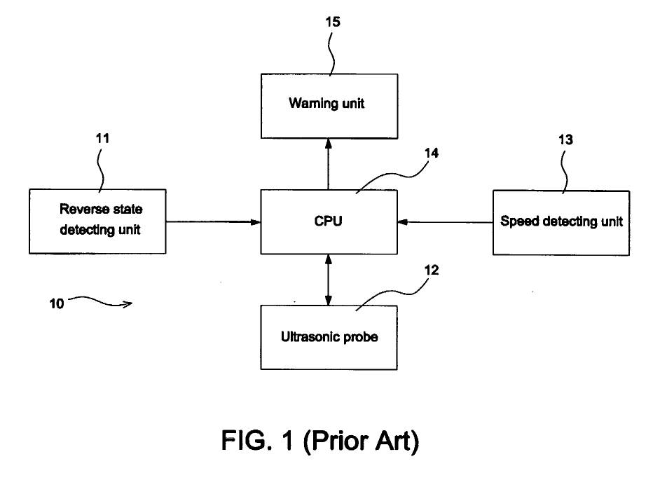

FIG. 2 is a schematic illustration showing a warning system for warning a following vehicle according to the invention.

### DETAILED DESCRIPTION OF THE INVENTION

The warning system for warning a following vehicle according to the invention will be described with reference to the accompanying drawings.

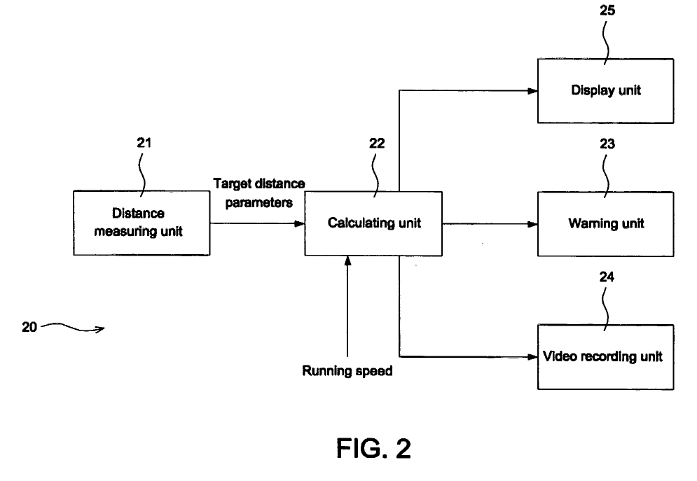

FIG. 2 is a schematic illustration showing a warning system 20 for warning a following vehicle to keep a safe distance according to the invention. Referring to FIG. 2, the warning system 20 includes a distance measuring unit 21, a calculating unit 22, a warning unit 23, a video recording unit 24 and a display unit 25.

The distance measuring unit 21 is composed of one, two or three of an ultrasonic distance measurer, a laser distance measurer and a radar. The distance measuring unit 21 is disposed on the vehicle and is preferably disposed on a rear portion of the vehicle to measure the distance from the vehicle to the following vehicle and output the obtained target distance. The calculating unit 22 receives the target distance and a running speed of the vehicle, and generates a first control signal and a second control signal according to the target distance and the running speed of the vehicle. The calculating unit 22 mainly generates a first distance parameter and a second distance parameter according to the running speed of the vehicle, wherein the first distance parameter and the second distance parameter are directly proportional to the running speed of the vehicle. Thereafter, the calculating unit 22 compares the target distance with the first distance parameter and the second distance parameter, enables the first control signal when the target distance is smaller than the first distance parameter, and enables the second control signal when the target distance is smaller than the second distance parameter. Because the present vehicle is often equipped with a vehicle computer, the running speed of the vehicle can be obtained from the vehicle computer. The warning unit 23 receives the first control signal and enables the warning operation when the first control signal is enabled. The video recording unit 24 receives the second control signal, and starts to record the video when the second control signal is enabled. The display unit 25 reads the running speeds of the vehicle and the following vehicle from the calculating unit 22 and displays the video on the back of the vehicle simultaneously.

The first distance parameter and the second distance parameter are directly proportional to the running speed. That is, the higher running speed represents that the safe distance between the vehicle and the following vehicle should be longer, so the first and second distance parameters should be larger. In addition, the second distance parameter is smaller than the first distance parameter, and is the lowest safe distance requested corresponding to the running speed. If the target distance parameter is smaller than the second distance parameter, it represents that the distance between the vehicle and the following vehicle is insufficient for the following vehicle to make an emergency brake when an accident occurs. Thus, when the target distance parameter is lower than the first distance parameter, the calculating unit 22 enables the first control signal to enable the warning unit 23. When the target distance parameter is lower than the second distance parameter, the second control signal is enabled to enable the video recording unit 24. If the target distance parameter is higher than the second distance parameter, the output of the video recording control signal is stopped. Then, if the target distance parameter is further higher than the first distance parameter, the output of the warning signal is stopped.

The warning unit 23 is composed of one, two or three of a warning bulb, a brake light and warning texts composed of light emitting diodes, or the warning unit 23 outputs the warning sound. The warning unit 23 generates the warning operation when the first control signal is enabled. The video recording unit 24 may be a typical video recorder. The display unit 25 is composed of one, two or three of a driver's display, a GPS satellite navigation display, and a digital television. Of course, the states of the first control signal and the second control signal may also be displayed on the display unit 25 that can be easily observed by the driver so as to inform the driver.

The warning system of the invention utilizes the active warning texts, the warning bulb and the video recording unit to warn the following vehicle to keep the safe distance. Compared with the passive warning system according to the prior art, in which a buzzer is utilized to inform the driver, the warning system of the invention can effectively prevent the behavior of the following vehicle without keeping the safe distance. Thus, the invention can create the safer and pressure-free driving environment.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

What is claimed is:

1. A warning system for warning a following vehicle, the warning system comprising:
a distance measuring unit, which is disposed on a vehicle, for measuring a distance from the vehicle to the following vehicle following the vehicle, and outputting a measured target distance parameter;
a calculating unit for receiving the target distance parameter and a running speed of the vehicle and comparing the target distance parameter with a first distance parameter and a second distance parameter to output a first control signal and a second control signal, respectively, wherein the first control signal is enabled when the target distance parameter is smaller than the first distance parameter, and the second control signal is enabled when the target distance parameter is smaller than the second distance parameter;
a warning unit for receiving the first control signal and generating a warning operation when the first control signal is enabled; and
a video recording unit, which is disposed on the vehicle, for receiving the second control signal and recording video in a backward direction of the vehicle when the second control signal is enabled,
wherein the first control signal and second control signal are calculated according to the running speed of the vehicle.

2. The warning system according to claim 1, wherein the distance measuring unit is composed of one, two of three of an ultrasonic distance measurer, a laser distance measurer and a radar.

3. The warning system according to claim 1, wherein the calculating unit is a central processing unit.

4. The warning system according to claim 1, wherein the running speed is read from a vehicle computer of the vehicle.

5. The warning system according to claim 1, wherein the video recording unit is a camera for shooting images in back of the vehicle.

6. The warning system according to claim 1, wherein the warning unit is composed of one, two or three of a warning bulb, a brake light and warning texts composed of light emitting diodes, and receives the warning signal to generate the warning operation.

7. The warning system according to claim 1, further comprising a display unit for displaying video in back of the vehicle, and the running speeds of the vehicle and the following vehicle.

8. The warning system according to claim 7, wherein the display unit is composed of one, two or three of a driver's display, a GPS satellite navigation display and a digital television.

9. The warning system according to claim 1, wherein the first control signal and second control signal are directly proportional to the running speed of the vehicle.
